(19) United States
(12) Patent Application Publication
(10) Pub. No.: US 2006/0106854 A1
(43) Pub. Date: May 18, 2006

(54) System and method for automatically including supplemental information in reminder messages

(76) Inventors: Karen Z. Haigh, Greenfield, MN (US); Wende L. Dewing, Minneapolis, MN (US); Stephen V. Metz, St. Paul, MN (US)

Correspondence Address: HONEYWELL INTERNATIONAL INC., 101 COLUMBIA ROAD, P O BOX 2245, MORRISTOWN, NJ, 07962-2245, US

(21) Appl. No.: 10/978,689

(22) Filed: Nov. 1, 2004

(51) Int. Cl. G06F 17/00; G06F 7/00

(52) U.S. Cl. 707/102

(57) ABSTRACT

A system for adding supplemental information to a reminder message to assist an actor comprises a database comprising supplemental information items related to reminders and a reminder module. The reminder module is adapted to determine that a reminder situation exists for which a reminder prompt is appropriate, determine whether to provide a supplemental information item with the reminder prompt, select a supplemental information item from the database relating to the reminder prompt situation upon determining to provide a supplemental information item with the reminder prompt, and generate a reminder message including the reminder prompt and the selected supplemental information item.

### CROSS-REFERENCE TO RELATED APPLICATIONS

This application is related to U.S. patent application Ser. No. 10/444,514, filed May 23, 2003, the teachings of which are incorporated herein by reference.

### BACKGROUND

The present invention relates to an automated system and method for generating reminder messages useful in assisting an actor in an environment. More particularly, it relates to a system and method for generating reminder messages including supplemental information items providing more effective visual and/or auditory cues for people with mental disabilities, such as dementia or confusion. Potential domains include, for example, in-home monitoring systems and eldercare.

Regardless of the complexity of a particular device or system, many devices are programmed to provide reminder messages or prompts to a user. For example, many handheld personal digital assistants (“PDA”) can be programmed to generate an alarm (e.g., a single tone or series of tones) at a time designated by the user to remind the user to perform a certain activity (e.g., attend a meeting). Further, many PDAs will display a text message (generated by the user) in conjunction with the alarm to provide some basic context to the reminder. For many users, this simplistic reminder approach is quite satisfactory. However, for other individuals suffering from mental disabilities such as dementia or confusion, these rudimentary reminders do not consistently promote full comprehension of the necessary action(s) to be taken in response to the reminder prompt. Unfortunately, current systems and devices do not provide additional reminder items (i.e., in addition to tone-type alarms and/or basic text messages) that might better facilitate a mentally disabled person's understanding of a reminder message.

Emerging sensing and automation technology represents an exciting opportunity to develop actor monitoring systems with applications to multiple, diverse environments. In this regard, a highly desirable feature associated with such a system is an ability to intelligently decide to issue a reminder message, determine whether supplemental information should be provided in the reminder message, and if so, select a supplemental information item(s) to include in the reminder message for prompting an actor with dementia or confusion to perform a particular activity.

### SUMMARY

One aspect of the present invention provides a system for adding supplemental information to a reminder message to assist an actor. The system comprises a database comprising supplemental information items related to reminders and a reminder module. The reminder module is adapted to determine that a reminder situation exists for which a reminder prompt is appropriate, determine whether to provide a supplemental information item with the reminder prompt, select a supplemental information item from the database relating to the reminder prompt situation upon determining to provide a supplemental information item with the reminder prompt, and generate a reminder message including the reminder prompt and the selected supplemental information item.

Another aspect of the present invention provides a system for automatically adding supplemental information to a reminder message to assist an actor with a mental disability. The system comprises a database comprising supplemental information items related to reminders and a controller. The supplemental information includes auditory and visual cues. The controller is adapted to determine that a reminder situation exits for which a reminder prompt is appropriate, determine to provide a supplemental information item with the reminder prompt, select a supplemental information item from the database relating to the reminder situation, and generate a reminder message including the reminder prompt and the selected supplemental information item.

### BRIEF DESCRIPTION OF THE DRAWINGS

FIG. 1 is a block diagram illustrating one embodiment of a system including a reminder module.

FIG. 2 is a flow diagram illustrating one embodiment of a method of generating a reminder message including supplemental information items for an actor with a mental disability.

FIG. 3 is a block diagram illustrating one embodiment of portions of the reminder module of FIG. 1.

FIG. 4 is a block diagram illustrating one embodiment of an in-home monitoring and response system including a reminder module.

FIG. 5 is a flow diagram illustrating one embodiment of a method of operation of the reminder module of FIG. 1.

### DETAILED DESCRIPTION

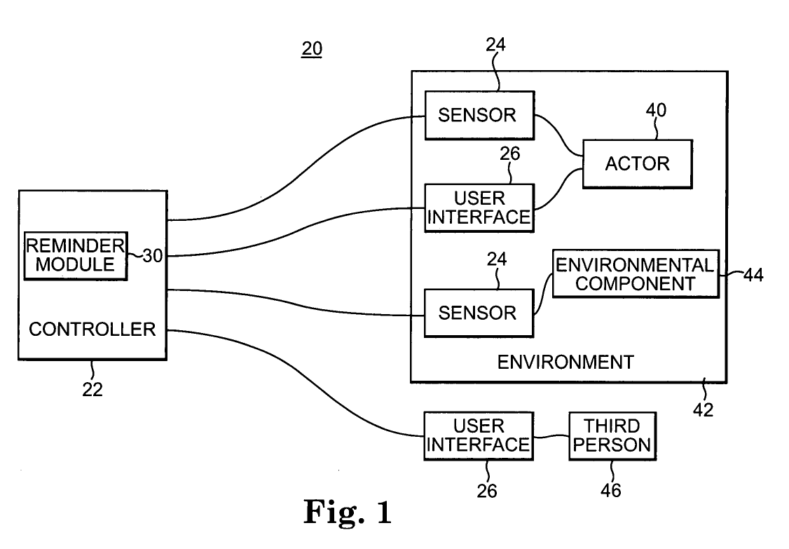

One preferred embodiment of a reminder system 20 in accordance with the present invention is shown in block form in FIG. 1. In most general terms, the system 20 includes a controller 22, one or more optional sensors 24, and one or more user interface devices 26 (with the sensor(s) 24 and the user interface device(s) 26 collectively referred to as “data sources”). The controller 22 includes a reminder module 30 for determining that a reminder situation exits, determining whether supplemental information should be provided with the reminder prompt, and if so, selecting a supplemental information item(s) to provide with the reminder prompt. The supplemental information items include visual and/or auditory cues to assist a person with a mental disability, such as dementia or confusion.

The optional sensor(s) 24 actively, passively, or interactively monitor activities of an actor or user 40 and/or segments of the actor's environment 42, such as one or more specified environmental components 44. Information or data from the sensor(s) 24 is signaled to the controller 22. The reminder module 30 determines whether a reminder situation exists relative to the actor 40 based on the information or data from the sensor(s) 24, a stimulus response mechanism, a schedule, or other suitable method. Under those circumstances, the reminder module 30 determines whether supplemental information should be included with the reminder prompt. If the reminder module 30 determines that supplemental information should be included with the reminder prompt, the reminder module 30 selects which supplemental information item(s) to include with the reminder prompt. The reminder module 30 then generates a reminder message including the reminder prompt and the selected supplemental information item(s) for prompting the actor to perform a particular activity. The reminder module 30 then prompts delivery or posing of the reminder message to the actor 40.

The supplemental information items include photos of familiar people, animations, videos, recorded or mimic voices of familiar people, photos of specific people, places, or things, or any other suitable visual and/or auditory cue that will prompt the actor 40 to perform the activity for which the reminder message is provided. The supplemental information items are maintained in a database that is updated by a third person 46, through a machine-learning module, or by other suitable means. The reminder messages may relate for example to medication, eating, appointments, tasks, security systems, toileting, emergencies, or any other activities in which the actor 40 engages in on a regular basis.

In one embodiment, the database of supplemental information items is organized by format (e.g., all photographs are stored in one directory, all video is stored in a second directory, all voice recordings are stored in a third directory, etc.). In another embodiment, the database of supplemental information items is organized by topic (e.g., all subject matter relating to medication is stored in one directory, all subject matter relating to personal grooming is stored in a second directory, all subject matter relating to nutrition is stored in a third directory, all subject matter relating to house maintenance is stored in a fourth directory, etc.). In this embodiment, some subject matter may be repeated, such as a doctor's voice saying, “remember to drink a glass of water,” which can apply to both medication and nutrition subjects. In another form of the invention, the database of supplemental information items is organized by use (i.e., wherein the most used content is stored in a first directory, and the least used content is stored in a second directory). In other embodiments, the database of supplemental information items may be organized in other ways.

Reminder module 30 determines whether to include supplemental information with a reminder prompt based on a number of factors. These factors include an evaluation of the reminder situation, an evaluation of the current state of the actor, the environmental context of the actor, the actor's previous response to the reminder prompt, etc. Once the reminder module 30 determines that a reminder situation exists and determines that a supplemental information item(s) should be included with the reminder prompt, reminder module 30 selects the supplemental information item(s) to include with the reminder prompt. Reminder module 30 determines what supplemental information item(s) to select based on a number of factors. These factors may include the actor's previous response to a reminder message including the supplemental information item(s), a caregiver's input selecting the supplemental information item(s) to include, a current situation of the actor, an environmental context of the actor, etc. Once the reminder module 30 has selected what supplemental information item(s) to include with the reminder prompt, the reminder module 30 generates a reminder message including the reminder prompt and the selected supplemental information item(s) and delivers, or prompts delivery of, the reminder message to the actor 40.

For example, reminder module 30 can determine a reminder situation exists based on a schedule for taking medication and the current time. Reminder module 30 determines that a photo of the medication should be included with the reminder prompt since a caregiver provided input to the system to include the photo with the reminder prompt. Reminder module 30 generates a reminder message including the reminder prompt and the photo of the medication and delivers, or prompts delivery of, the reminder message to the actor 40.

The following description of the present invention is with respect to but one acceptable domain of an actor or patient in an in-home or care (e.g., eldercare) daily living environment. Any environment in which an actor spends a significant amount of time (e.g., two or more hours) on a regular basis is considered a “daily living environment,” or simply “an environment” of the actor 40 in which the present invention is useful. Similarly, the “third person” 46 is any person familiar with the actor 40. For example, where the actor 40 is a person in a daily care environment, the third person 46 can be a relative, friend, neighbor, or formal caregiver of the actor 40.

The key component associated with the system 20 resides in the reminder module 30 associated with the controller 22. As such, the sensor(s) 24 and the actor interface device(s) 26 assume a wide variety of forms. Preferably, the sensors 24 are networked by the controller 22. The sensors 24 are non-intrusive or intrusive, active or passive, wired or wireless, physiological or physical. In short, the sensors 24 include any type of sensor that provides information relating to activities of the actor 40 or other information relating to the actor's environment 42, including one or more of the environmental component(s) 44.

For example, the sensors 24 can include the current time, a medication caddy, light level sensors, “smart” refrigerators, water flow sensors, motion detectors, pressure pads, door latch sensors, panic buttons, toilet-flush sensors, microphones, cameras, fall-sensors, door sensors, heart rate monitor sensors, blood pressure monitor sensors, glucose monitor sensors, moisture sensors, telephone sensors, thermal sensors, optical sensors, seismic sensors, etc. In addition, one or more of the sensors 24 can be a sensor or actuator associated with a device or appliance used by the actor 40, such as a stove, oven, television, telephone, security pad, medication dispenser, thermostat, computer interface, etc., with the sensor or actuator providing data indicating that the device or appliance is being operated by the actor 40 (or someone else).

Similarly, the user interface device(s) 26 also assumes a wide variety of forms. Examples of applicable interface devices 26 include computers, displays, televisions, keyboards, web pads, telephones, pagers, speaker systems, etc. In general terms, the user interface device 26 is configured to interact with the actor 40 (or the third person 46), providing specific information and receiving inputs. For example, the user interface device 26 can be a “standard” personal computer that presents visual reminder messages to the actor 40 via a display screen. Alternatively, or in addition, the actor interface device 26 can be a home audio system operated to audibly provide reminder messages to the actor 40.

The manner and format, in which information is provided to the reminder module 30, as well as the assessment techniques performed thereby, are discussed in greater detail below. Generally speaking, the reminder module 30 is provided with “raw data” from which the reminder module 30 independently determines circumstance(s) of the actor 40. Alternatively, the “raw data” is first reviewed and quantified by one or more other components/modules of the controller 22, with the resultant “information” being provided to the reminder module 30 in the form of a conclusion (e.g., “the actor is eating lunch”). With this in mind, the reminder module 30 is adapted to evaluate information in a wide variety of contexts, determine that a reminder situation exists, determine whether supplemental information should be included with the reminder prompt, and if so, select a supplemental information item(s) to include with the reminder prompt based upon an intelligent review of, in a preferred embodiment, multiple circumstances.

In this context, then, the reminder module 30 evaluates the sensed situation before determining that a reminder situation exists, determining whether supplemental information should be included with the reminder prompt, and selecting a supplemental information item(s) to be included with the reminder prompt, rather than simply automatically delivering a reminder message in response to one specific action by the actor 40. Of course, the reminder module 30 can be programmed to provide scheduled reminders or to include a stimulus-response mechanism (e.g., a reminder message is issued to the actor 40 every time the actor 40 presses a “help” key on the interface device 26).

For example, the reminder module 30 can be provided with (or independently determine) information indicating that the actor 40 has not eaten breakfast. Under these circumstances, then, the reminder module 30 would determine that a reminder situation exists, determine that supplemental information should be included with the reminder prompt, and select a supplemental information item(s) to be included with the reminder prompt. The reminder module 30 then generates and prompts delivery of an appropriate reminder including the reminder prompt and the selected supplemental information item(s) prompting the actor 40 to eat breakfast. The supplemental information item(s) could include a photo of a cereal box and/or a recorded or mimic voice of a caregiver stating: “Don't forget to eat your breakfast” or similar statement.

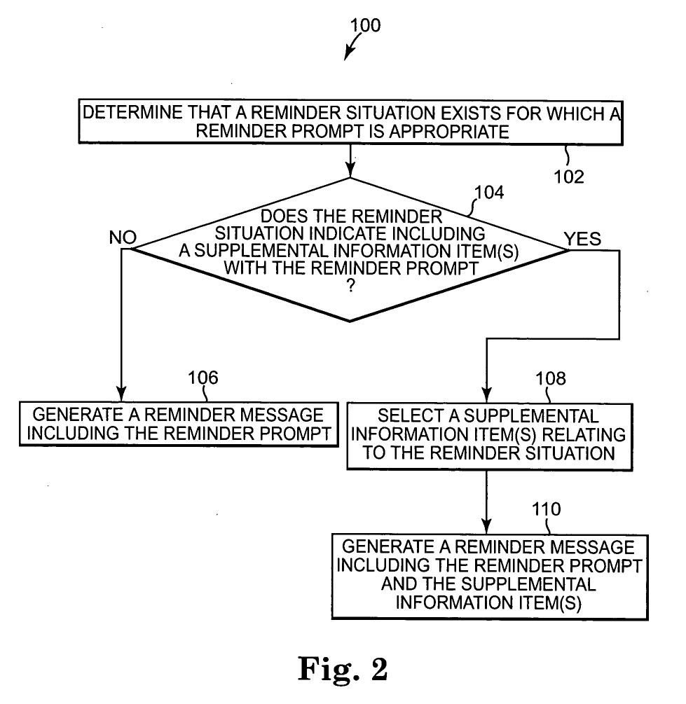

The above example is but one of a virtually endless listing of possible circumstances under which the reminder module 30 will determine or recognize that a reminder situation exists. With this in mind, FIG. 2 illustrates a flow diagram 100 illustrating one embodiment of a method for generating a reminder message. At 102, reminder module 30 determines that a reminder situation exists for which a reminder prompt is appropriate. At 104, reminder module 30 determines whether the reminder situation indicates including a supplemental information item(s) with the reminder prompt.

If the reminder module 30 determines that a supplemental information item(s) should not be included with the reminder prompt, then at 106 the reminder module 30 generates a reminder message including the reminder prompt absent any supplemental information item(s). The reminder module 30 determines that supplemental information items should not be included with the reminder prompt based on the availability of supplemental information items for the reminder situation in the database of supplemental information items, the actor's previous response to the reminder prompt, the environmental context of the actor, input from a machine learning module, etc.

If the reminder module 30 determines that a supplemental information item(s) should be included with the reminder prompt, then at 108 the reminder module 30 selects a supplemental information item(s) relating to the reminder situation. The selection of a supplemental information item(s) is based on the actor's previous response to a reminder message, the environmental context of the actor, input from a machine learning module, input from a caregiver of the actor, etc. At 110, the reminder module 30 generates a reminder message including the reminder prompt and the selected supplemental information item(s).

In further reference to FIG. 1, the system 20 assumes a wide variety of forms that provide the reminder module 30 with the ability to recognize the existence of a reminder situation, determine whether supplemental information should be included with the reminder prompt, and select which supplemental information item(s) to include with the reminder prompt. The manner in which the reminder module 30 receives information from the various sensor(s) 24 and/or the user interface device(s) 26 as well as the format of that information (i.e., whether the reminder module 30 receives raw data directly from the sensors and devices 24, 26 or if the raw data is first processed by one or more other system modules that analyze, either alone or in combination, the sensor and/or interface device data and present analyzed information and/or conclusions to the reminder module 30) is a function of the overall system 20 configuration relative to the actor 40 and the actor's environment 42, and in particular the controller 22 architecture. The controller 22 is preferably a microprocessor-based device capable of storing and operating preferred modules, including the reminder module 30. The components of the present invention are implemented in hardware via a microprocessor, programmable logic, or state machine, in firmware, or in software with a given device.

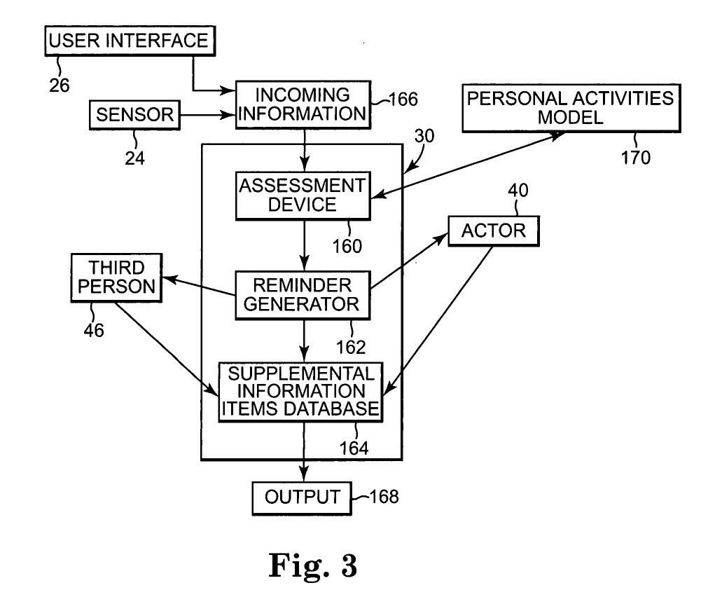

Depending upon the complexity of the particular installation, the controller 22 includes and operates a number of additional modules, the relationships of which relative to the reminder module 30 are described in greater detail below. In general terms, however, and with reference to FIG. 3, the reminder module 30 includes or provides, in one embodiment, an assessment device 160, a reminder generator 162, and a supplemental information items database 164 including visual and/or auditory cues for prompting the actor 40 to perform particular activities. In one embodiment, the reminder module 30 is communicatively coupled to a personal activities model 170.

In one embodiment, the assessment device 160 receives information/data (shown generally at 166) from the sensor(s) 24, the interface device(s) 26 (FIG. 1) and/or one or more other modules, as described below through an appropriate interface or link. The assessment device 160 reviews the received information 166 and determines whether a reminder situation exists, determines whether supplemental information should be provided with the reminder prompt, and if so, selects a supplemental information item(s) to be included with the reminder prompt.

Regardless of how a reminder situation is recognized, the reminder generator 162 creates an appropriate reminder message relating to the reminder situation, and if indicated, selects an appropriate supplemental information item(s) from the database 164. The supplemental information item(s) includes a visual and/or auditory cue for prompting the actor 40 to perform a particular activity. For example, a reminder message to take a certain medication can include the voice of a family member or doctor reminding the actor 40 to take the medication and include a photo of the pill so as to better distinguish the medication from other medications taken by the actor 40. Another example includes displaying a photograph of the doctor the actor 40 is scheduled to meet with. The reminder generator 162 (or other module otherwise receiving the relevant reminder information from the reminder generator 162) delivers, or prompts the delivery of, the reminder message to the actor 40. For example, the reminder message can be delivered to the actor 40 via the interface device 26, with the reminder module 30 directly or indirectly communicating with the interface device 26.

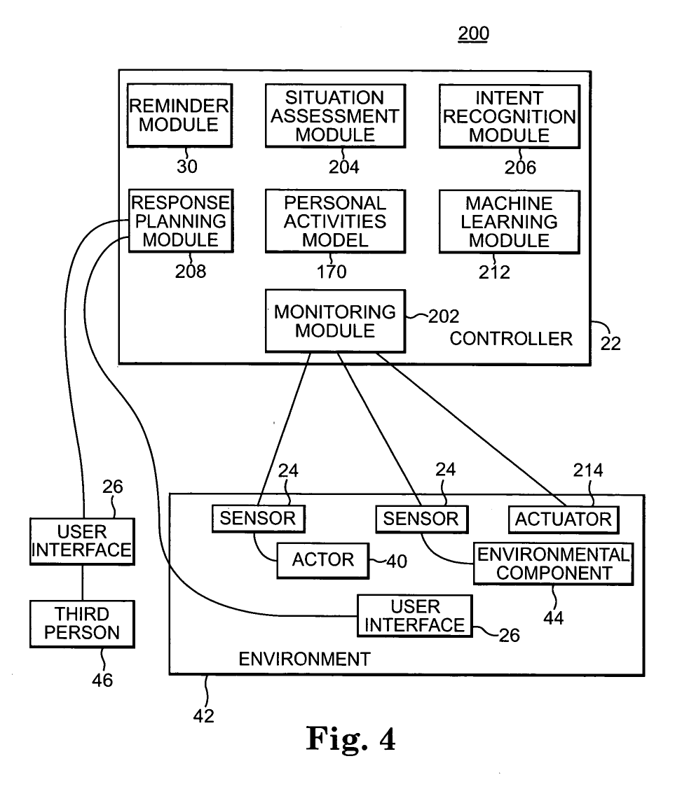

In one preferred embodiment, the system of the present invention is provided as part of an in-home, automated monitoring and response system 200 as shown in block form in FIG. 4. Configuration and operation of the monitoring and response system 200 is described in greater detail in U.S. patent application Ser. No. 10/341,355, filed Jan. 10, 2003 and entitled “System and Method for Automated Monitoring, Recognizing, Supporting, and Responding to the Behavior of an Actor,” the teachings of which are incorporated herein by reference. In general terms, the system 200 includes the controller 22 that provides the reminder module 30 along with other modules such as the personal activities model 170, a monitoring module 202, a situation assessment module 204, an intent recognition module 206, a response planning module 208, and a machine learning module 212.

The provided sensor(s) 24 and the user interface device(s) 26 actively, passively, or interactively monitor activities of the actor 40 as well as segments of the actor's environment 42. Information or data from the sensor(s) 24 and interface device(s) 26 is signaled to the controller 22 for interpretation by the monitoring module 202. The situation assessment module 204 processes information from the monitoring module 202 to determine what the actor 40 is doing, along with what is happening in the actor's environment 42. The intent recognition module 206 functions to determine what the actor 40 is intending to do. Based upon information from the situation assessment module 204 and the intent recognition module 206, the reminder module 30 generates appropriate reminder messages, including supplemental information items if indicated, that are carried out through the response planning module 208 and by actuator(s) 214 (it being understood that the interface device 26 is characterized as either a sensor or an actuator).

The learning module 212 “optimizes” operation of the situation assessment module 204, the intent recognition module 206, the reminder module 30, and the response planning module 208 based upon automatically generated learned models of behavior formulated from information provided by the sensor(s) 24 and/or the interface device(s) 26. One example of an acceptable machine-learning module is described in U.S. patent application Ser. No. 10/339,941, filed Jan. 10, 2003, the teachings of which are incorporated herein by reference. Other modules can be provided to augment the capabilities of the system 200. It will be understood that the system 200 of FIG. 4 is but one acceptable configuration, and that one or more of the modules 202-212 can be eliminated and/or other modules added.

As part of the above operations, the reminder module 30 receives information directly from the monitoring module 202 or indirectly via one or more of the situation assessment module 204, the intent recognition module 206, and the machine-learning module 212. In this regard, the reminder module 30 can be provided as part of one or more of the other modules 204-212, for example as part of the situation assessment module 204. With additional reference to FIG. 2, then, the modules 202-212 assist the reminder module 30 in intelligently recognizing the existence of a reminder situation and intelligently determining if and what supplemental information items should be included in the reminder message.

For example, the monitoring module 202 can signal sensor 24/interface device 26 data otherwise indicative of an action by the actor 40 directly to the reminder module 30. In one embodiment, all sensor 24/interface device 26 information is signaled to the reminder module 30 that in turn is adapted to extract or parse information known to be indicative of an “action.” Alternatively, the monitoring module 202 can be adapted to review the sensor 24/interface device 26 information and determine the occurrence of an “action,” with this action-specific information or conclusion then being provided to the reminder module 30. The determination of whether an unexpected action has occurred or whether an expected action has not occurred is obtained by reference to action parameters within the personal activities model 170 maintained by the reminder module 30 (or other module(s)), by reference to the machine-learning module 210, or both. For example, the machine learning module 212 can indicate that the actor 40 normally eats breakfast before leaving home. Where the reminder module 30 learns/determines that the actor 40 is about to leave home without eating breakfast, the reminder module 30 recognizes that a reminder situation exists based upon reference to the “normal” eating breakfast information provided by the machine learning module 212.

The situation assessment module 204 is similarly capable of evaluating information from the monitoring module 202 and determining whether the actor 40 is engaged in a particular activity. This activity information is then provided to the reminder module 30 for evaluation as to whether the activity gives rise to a reminder situation as previously described. Alternatively, the reminder module 30 can, based upon reference to the machine learning module 212, determine that the actor 40 is expected to be engaged in a particular activity; where the situation assessment module 204 otherwise indicates that the actor 40 is not engaged in the expected activity, the reminder module 30 can then evaluate as to whether these circumstances give rise to a reminder situation.

The situation assessment module 204 is further provided with the capability of recognizing, based upon information from the monitoring module 202, when the actor 40 is engaged in a particular task with reference to information provided by the intent recognition module 206. In general terms, the situation assessment module 204 concludes that the actor 40 is engaging in a particular task or has a particular goal based upon currently sensed actions of the actor 40 and/or events in the environment 42. One acceptable system and method for accomplishing this task/goal recognition is provided in U.S. patent application Ser. No. 10/444,514, filed May 23, 2003, the teachings of which are incorporated herein by reference.

In one preferred embodiment, the intent recognition module 206 assists or performs the task or goal recognition operation. In general terms, the intent recognition module 206 incorporates simple hierarchical (task decomposition) plans, and references information in a plan library (not shown), observed actions, and, in a preferred embodiment, hypothesized unobserved actions to recognize or evaluate the likelihood that the actor 40 is engaged in a particular task otherwise described in the plan library. The preferred capability of probabilistically recognizing a task or goal of the actor 40 in a manner that accounts for the possible occurrence or execution of unobserved actions is accomplished in a variety of fashions, one embodiment of which is described in U.S. patent application Ser. No. 10/286,398, filed Nov. 1, 2002, the teachings of which are incorporated herein by reference.

Regardless, the reminder module 30 is informed that the actor 40 is engaged in a particular task or has a certain goal. As previously described, the reminder module 30 evaluates these circumstances as giving rise to a reminder situation. Alternatively, or in addition, the reminder module 30 tracks the actor's 40 progress in completing the task or achieving the goal. This tracking information is provided directly to the reminder module 30 via the monitoring module 202 and/or via the situation assessment module 204 that can otherwise correlate information from the monitoring module 202 relative to the identified task or goal, properly categorizing information from the monitoring module 202 as indicating that a particular “step” of the task or goal is being attempted or has been completed by the actor 40. Regardless, the reminder module 30 is given information indicative of the actor's 40 progress, such that the reminder module 30 evaluates the actor's 40 progress (or lack thereof) as possibly giving rise to a reminder situation. Finally, the situation assessment module 204 is capable of determining, based upon information from the monitoring module 202, when the actor 40 has completed the task or accomplished the goal. This information is provided to the reminder module 30 that in turn recognizes that a reminder message or additional reminder message is not required based upon an evaluation of the information.

With the one embodiment of FIG. 4, the response-planning module 208 is adapted to provide reminder messages to the actor 40 under a variety of circumstances. For example, the situation assessment module 204 can prompt the response planning module 208 to issue a reminder message at predetermined times and/or periodically when warranted by a particular, assessed situation. The reminder module 30 is informed of when, how, or if the actor 40 responds to the reminder message, either directly via interpretation of information provided by the monitoring module 202 or indirectly via the situation assessment module 204 that otherwise processes information from the monitoring module 202. As previously described, the reminder module 30 then evaluates the actor's 40 response to the reminder message to determine or recognize the existence of an additional reminder situation and to determine or recognize which supplemental information item(s) are effective in prompting the actor 40 to perform the particular activity.

It will be understood that the above system 200 is but one example of an acceptable configuration that otherwise facilitates automatic recognition of a reminder situation, recognition of a need to provide supplemental information, and selection of supplemental information item(s) by the reminder module 30. Further, the listed circumstances under which the reminder module 30 might declare that a reminder situation exists are not limited to the above examples.

Regardless of the circumstances under which the reminder module 30 recognizes the existence of a reminder situation, the reminder module 30 then generates an appropriate reminder message, including supplemental information items if indicated, for presentation to the actor 40. In one embodiment, the reminder module 30 initiates the issuance of a reminder message by providing the response-planning module 208 with information relating to the desired reminder message. The reminder module 30, in one embodiment, generates the exact reminder message format and decides upon the preferred mode of presentation to the actor 40. Alternatively, the response-planning module 208 generates the reminder message based upon information from the reminder module 30, the device through which the reminder message will be presented, and the timing of the reminder message.

The reminder message is presented to the actor 40 in one or more of a multitude of ways including, for example, via an audio component (e.g., telephone or speaker system), visual component (e.g., personal computer display screen, television, etc.), or both. Further, based upon information from the machine learning module 212, the response planning module 208 and/or the reminder module 30, an optimal format and content for the reminder message most likely to prompt a response from the actor 40 (e.g., the machine learning module 212 indicates that the actor 40 is most likely to respond to a reminder message consisting of only a few words and a photograph) is determined.

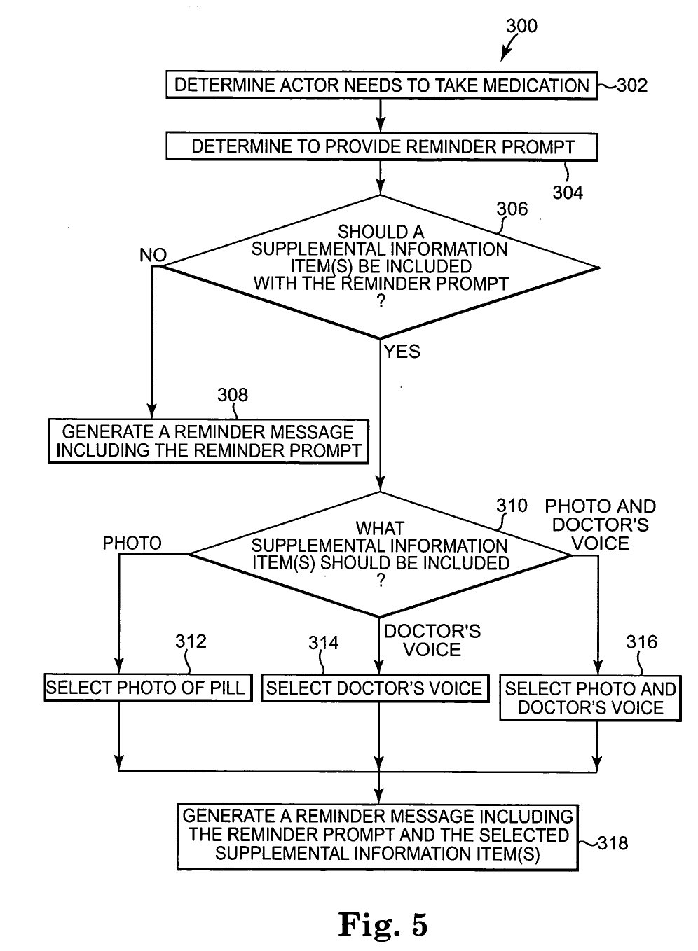

Operation of the reminder module 30 is best illustrated by the exemplary scenario provided in flow diagram 300 of FIG. 5. At 302, reminder module 30 determines that the actor needs to take their medication. At 304, reminder module 30 determines that a reminder prompt should be generated and provided to the actor based on the situation assessment module input or input from other modules. At 306, reminder module 30 determines whether a supplemental information item(s) should be included with the reminder prompt.

If the reminder module 30 determines that a supplemental information item(s) does not need to be included with the reminder prompt, or supplemental information related to the medication is not available in the supplemental information items database, then at 308 the reminder module 30 generates a reminder message. The reminder message includes the reminder prompt to the actor to take their medication, but does not include any supplemental information item(s).

If the reminder module 30 determines that a supplemental information item(s) is available and should be included with the reminder prompt, then at 310 the reminder module 30 determines what supplemental information item(s) should be included. In this case, the reminder module 30 determines that there are three options for supplemental information items. If reminder module 30 determines that it would be best to include a photo of the medication, then at 312 the reminder module 30 selects a photo of the pill or medication. If the reminder module 30 determines that a doctor's voice saying “take your medication” or similar reference should be included with the reminder prompt, then at 314 the reminder module 30 selects the doctor's voice. If the reminder module 30 determines that both the photo and the doctor's voice should be included with the reminder prompt, then at 316, reminder module 30 selects both the photo and the doctor's voice to include with the reminder prompt. At 318, reminder module 30 generates a reminder message including the reminder prompt and the selected supplemental information item(s).

The system and method of the present invention provides a marked improvement over previous designs. In particular, the system and method is capable of intelligently reminding an actor with a mental disability, such as dementia or confusion, by providing a reminder prompt and supplemental information items, if indicated, in a reminder message for prompting the actor to perform particular activities. In addition, the reminder messages can be based on preprogrammed scheduled events or on knowledge of the actor's situation or environment.

Although the present invention has been described with reference to preferred embodiments, workers skilled in the art will recognize that changes can be made in form and detail without departing from the spirit and scope of the present invention.

What is claimed is:

1. A system for adding supplemental information to a reminder message to assist an actor, the system comprising:
a database comprising supplemental information items related to reminders; and
a reminder module adapted to:
determine that a reminder situation exists for which a reminder prompt is appropriate;
determine whether to provide a supplemental information item with the reminder prompt;
select a supplemental information item from the database relating to the reminder prompt situation upon determining to provide a supplemental information item with the reminder prompt; and
generate a reminder message including the reminder prompt and the selected supplemental information item.

2. The system of claim 1, further comprising:
a sensor for monitoring activities of the actor; and
a situation assessment module adapted to interpret the sensor data to determine a current activity of the actor,
wherein the reminder module is further adapted to determine that a reminder situation exists based upon the current activity of the actor.

3. The system of claim 1, wherein the reminder module is further adapted to determine that a reminder situation exists based upon a schedule.

4. The system of claim 1, wherein the reminder module is further adapted to determine that a reminder situation exists based upon a stimulus-response mechanism.

5. The system of claim 1, wherein the reminder module is further adapted to determine whether to provide a supplemental information item based upon an evaluation of a current situation.

6. The system of claim 1, wherein the reminder module is further adapted to determine whether to provide a supplemental information item based upon an evaluation of a current state of the actor.

7. The system of claim 1, wherein the reminder module is further adapted to determine whether to provide a supplemental information item based upon an evaluation of a current state of an environment of the actor.

8. The system of claim 1, wherein the reminder module is further adapted to determine whether to provide a supplemental information item based upon the supplemental information items available in the database.

9. The system of claim 1, further comprising:
a machine learning module, wherein the reminder module is further adapted to determine whether to provide a supplemental information item based upon information from the machine learning module.

10. The system of claim 1, further comprising:
a machine learning module, wherein the reminder module is further adapted to select a supplemental information item based upon information from the machine learning module.

11. The system of claim 1, further comprising:
a machine learning module adapted to add supplemental information items to the database.

12. The system of claim 1, wherein the supplemental information items comprises at least one of an auditory cue, a visual cue, and an audiovisual cue.

13. The system of claim 12, wherein the auditory cue comprises one of a voice and a non-voice.

14. The system of claim 13, wherein the voice comprises one of a voice of a caregiver of the actor and a voice of a family member of the actor.

15. The system of claim 12, wherein the visual cue comprises one of an image, a video, and lights turning on and off.

16. The system of claim 12, wherein the audiovisual cue comprises one of a video and an animation.

17. A system for automatically adding supplemental information to a reminder message to assist an actor with a mental disability, the system comprising:
a database comprising supplemental information items related to reminders, the supplemental information including auditory and visual cues; and
a controller adapted to:
determine that a reminder situation exits for which a reminder prompt is appropriate;
determine to provide a supplemental information item with the reminder prompt;
select a supplemental information item from the database relating to the reminder situation; and
generate a reminder message including the reminder prompt and the selected supplemental information item.

18. The system of claim 17, wherein the controller is further adapted to determine to provide a supplemental information item based upon the actor's previous response to the reminder message.

19. The system of claim 17, wherein the controller is further adapted to determine to provide a supplemental information item based upon a caregiver's input to the system.

20. The system of claim 17, wherein the controller is further adapted to select a supplemental information item based upon the actor's previous response to the reminder message.

21. The system of claim 17, wherein the controller is further adapted to select a supplemental information item based upon an environmental context of the actor.

22. The system of claim 17, wherein the controller is further adapted to determine that a reminder situation exists based upon a schedule.

23. The system of claim 17, wherein the controller is further adapted to determine that a reminder situation exists based upon an environmental context of the actor.

24. A method for automatically generating a reminder message to assist an actor with a mental disability, the method comprising:
determining that a reminder situation exists for which a reminder prompt is appropriate;
determining whether to provide a supplemental information item with the reminder prompt;
selecting a supplemental information item relating to the reminder situation upon determining to provide a supplemental information item with the reminder prompt; and
generating a reminder message including the reminder prompt and the selected supplemental information item.

25. The method of claim 24, wherein determining whether to provide a supplemental information item is based upon the actor's previous response to the reminder message.

26. The method of claim 24, wherein determining whether to provide a supplemental information item is based upon a caregiver's input.

27. The method of claim 24, wherein selecting a supplemental information item is based upon the actor's previous response to the reminder message.

28. The method of claim 24, wherein selecting a supplemental information item is based upon an environmental context of the actor.

29. The method of claim 24, wherein selecting a supplemental information item comprises selecting one of an auditory cue, a visual cue, and an audiovisual cue.
